(19) United States
(12) Patent Application Publication
(10) Pub. No.: US 2023/0112279 A1
(43) Pub. Date: Apr. 13, 2023

(54) DETERGENT COMPOSITION

(71) Applicant: Conopco, Inc., d/b/a UNILEVER, Englewood Cliffs, NJ (US)

(72) Inventors: Sarah Louise HOSKING, Mold (GB); Dietmar Andreas LANG, Liverpool (GB); Mark Lawrence THOMPSON, Ellesmere Port (GB); Ian Malcolm TUCKER, Chester (GB)

(73) Assignee: Conopco, Inc., d/b/a UNILEVER, Englewood Cliffs, NJ (US)

(21) Appl. No.: 17/910,754

(22) PCT Filed: Mar. 16, 2021
(86) PCT No.: PCT/EP2021/056734

§ 371 Date: Sep. 9, 2022

(30) Foreign Application Priority Data
Mar. 19, 2020 (EP) 20164151.1

(51) Int. Cl. C11D 3/386; C11D 1/83; C11D 3/37; C11D 3/22; C11D 1/02

(52) U.S. Cl. CPC C11D 3/3869; C11D 1/83; C11D 3/3723; C11D 3/3715; C11D 3/22; C11D 3/38627; C11D 1/02

(57) ABSTRACT

The invention provides a method of inhibiting lipase activity in a detergent composition, said method involving incorporation of from 0.25 to 40 wt. % of a saponin into said lipase containing composition, wherein said detergent composition preferably is a home care detergent composition, more preferably a laundry detergent composition; and to the use of saponin to inhibit lipase activity in a detergent composition, preferably a laundry detergent composition, wherein the saponin is present in the detergent formulation at a level of from 0.25 to 40 wt. %, wherein said detergent composition preferably is a home care detergent composition, more preferably a laundry detergent composition.

### FIELD OF INVENTION

The invention concerns a detergent composition, in particular a detergent composition comprising a lipase and a saponin.

### BACKGROUND OF THE INVENTION

Lipase enzymes are also a useful ingredient for detergent formulations, particularly for laundry detergents. However, the lipase enzymes are a costly ingredient and it is desirable to enhance the lipase activity to enable less to be used or to boost the cleaning potential of the resulting formulations.

So there is a need for detergent compositions with enhanced lipase activity.

However, the lipase is generally incompatible with many useful detergent formulation ingredients, for example soil release polymers, particularly polyester based soil release polymers, as the lipase degrades the soil release polymer. This problem is particularly pronounced in liquid detergent compositions.

There is also a need for detergent compositions where the lipase can be inhibited in the composition and so allow the formulation to include ingredients susceptible to lipase degradation.

### SUMMARY OF THE INVENTION

We have found that the incorporation of saponins at certain levels in detergent compositions inhibits lipase activity in the detergent formulation and/or enhances lipase activity when diluted in wash conditions.

In a first aspect of the invention, there is provided a method of inhibiting lipase activity in a detergent composition, said method involving incorporation of from 0.25 to 40 wt. %, preferably from 0.5 to 30 wt. %, more preferably from 0.5 to 25 wt. %, more preferably from 1 to 20 wt. %, most preferably from 1 to 15 wt. %, of a saponin into said lipase containing composition, wherein said detergent composition preferably is a home care detergent composition, more preferably a laundry detergent composition.

In a second aspect of the invention, there is provided the use of saponin to inhibit lipase activity in a detergent composition, preferably a laundry detergent composition, wherein the saponin is present in the detergent formulation at a level of from 0.25 to 40 wt. %, preferably from 0.5 to 30 wt. %, more preferably from 0.5 to 25 wt. %, more preferably from 1 to 20 wt. %, most preferably from 1 to 15 wt. %, of a saponin, wherein said detergent composition preferably is a home care detergent composition, more preferably a laundry detergent composition.

Preferably in the method or use, the detergent composition comprises:

(i) from 0.25 to 40 wt. %, preferably from 0.5 to 30 wt. %, more preferably from 0.5 to 25 wt. %, more preferably from 1 to 20 wt. %, most preferably from 1 to 15 wt. %, of a saponin; and,

(ii) from 0.0005 to 2.5 wt. %, preferably from 0.001 to 2 wt. %, more preferably from 0.005 to 1 wt. % of a lipase enzyme.

Preferably the lipase is bacterial or fungal in origin.

Preferably the saponin has a triterpenoid backbone, and one or more sugar moieties attached to the triterpenoid backbone. More preferably there are at least two sugar moieties attached to the triterpenoid backbone.

Preferably the detergent composition comprises from 1 to 60 wt. %, preferably from 2.5 to 50 wt. %, more preferably from 4 to 40 wt. %, most preferably from 8 to 35 wt. % of a surfactant, said surfactant not including saponin.

Preferably the detergent composition comprises anionic and/or nonionic surfactant, more preferably the detergent composition comprises both anionic and nonionic surfactant.

A preferred detergent composition is a laundry detergent composition. Preferably the laundry detergent composition is a liquid, gel or a powder, more preferably the detergent is a liquid detergent.

The laundry detergent preferably comprises from 0.1 to 8 wt. % of an alkoxylated polyamine. Preferably the alkoxylated polyamine comprises an alkoxylated polyethylenimine, and/or alkoxylated polypropylenimine, more preferably the alkoxylation is ethoxylation or propoxylation or a mixture of both.

Preferably the laundry detergent composition comprises a soil release polymer, preferably at a level of from 0.1 to 8 wt. %, more preferably from 0.2 to 6 wt. %, even more preferably from 0.5 to 5 wt. %, most preferably from 1 to 5 wt. %, most preferably the soil release polymer is a polyester soil release polymer.

Preferred detergent compositions, particularly laundry detergent compositions additionally comprise one or more further enzymes selected from: proteases, cellulases, alpha-amylases, peroxidases/oxidases, pectate lyases, and/or mannanases, and mixtures thereof.

### BRIEF DESCRIPTION OF THE FIGURES

FIG. 1 is a figure showing the dose response of Lipex 100 L to escin saponin in a biochemical assay

FIG. 2 is a figure that shows the dose response of various other lipases to escin saponin in a biochemical assay

FIG. 3 is a figure that shows the activation of a lipase (Lipex 100 L) by a variety of saponins at a fixed concentration of 10 μM

FIG. 4 is a figure that expresses the same data as FIG. 3, but this time superimposed on a plot of Lipex 100 L activity vs. concentration. This clearly shows that 10 μM of a saponin can have the same impact on lipase activity as increasing the lipase concentration from 10 to 50 ng/ml. Given enzymes are typically the most expensive ingredient in a laundry formulation, the inclusion of saponin could significantly decrease the amount of enzyme required and hence reduce the total raw material cost of the formulation.

FIG. 5 is a figure showing the activation effect of escin saponin on lipase at low temperature cleaning of solid fat stains.

FIG. 6 is a figure showing the simulation of in-wash dilution of lipase using MTP-based biochemical activity assay. The figure shows how a dilution of the stored lipase/saponin sample (replicating the in-wash dilution) releases the inhibitory effect of the saponin, thus restoring activity. This is represented by a significantly higher lipase activity despite a 1/400 dilution from the stored sample. Laundry formulation contained 0.4% w/v Lipex and 5 mM QBS (Quillaja Bark saponin).

FIG. 7 is a figure that highlights that a maximum final saponin concentration of 1 mM in this formulation is advised (after dilution into wash) to ensure that full lipase cleaning performance towards a beef fat stain (CS61) is maintained. Wash conducted at 30° C. for 30 min in FH32 water and with 1 g/L formulation containing: LAS 5.8%, SLES 4.5%, NI (Neodol 25-7) 4.5%, fatty acid 0.9%, TEA 8.8%, glycerol 2%, citric acid 1%, polymers/perfume/preservative (5%), and water to 100%).

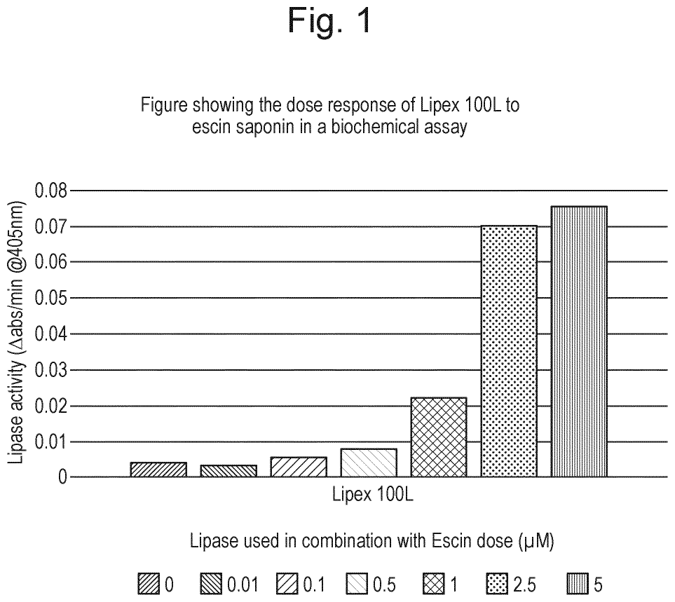

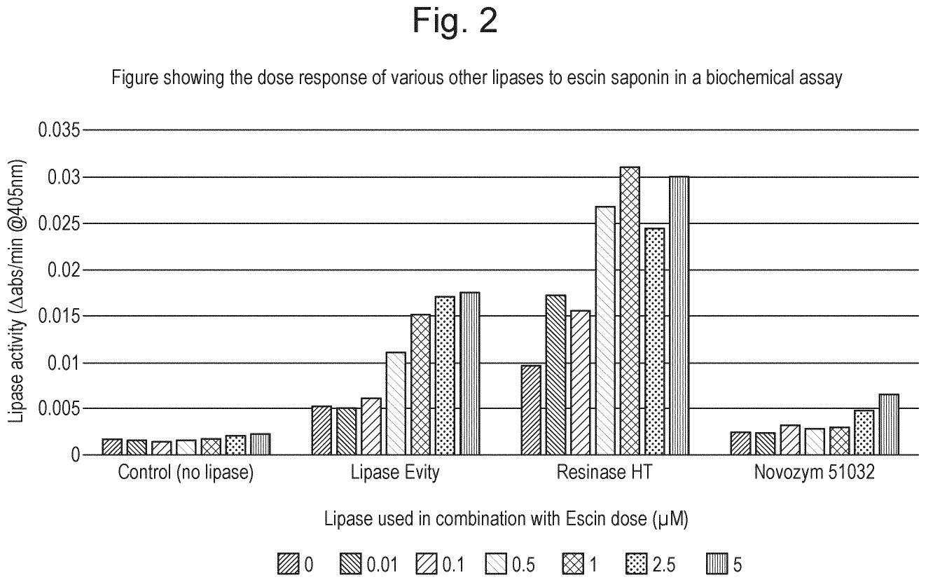

### DETAILED DESCRIPTION OF THE INVENTION

The indefinite article “a” or “an” and its corresponding definite article “the” as used herein means at least one, or one or more, unless specified otherwise.

All % levels of ingredients in compositions (formulations) listed herein are in wt. % based on total formulation unless other stated.

It is understood that any reference to a preferred ingredient of the detergent composition is envisaged to be combinable subject matter with any other preferred ingredient of the detergent composition disclosed herein.

The detergent composition may take any suitable form, for example liquids, solids (including powders) or gels.

The detergent composition can be applied to any suitable substrate, including but not limited to any substrate to which a home care composition would be applied, for example, textiles, crockery and cutlery. Particularly preferred substrates are textiles. Particularly preferred detergent compositions are laundry detergent compositions. Preferably the laundry detergent composition is a liquid, gel or a powder, more preferably the detergent is a liquid detergent.

Laundry detergent compositions may take any suitable form. Preferred forms are liquid or powder, with liquid being most preferred.

Lipase

The composition comprises from 0.0005 to 2.5 wt. %, preferably from 0.001 to 2 wt. %, more preferably from 0.005 to 1 wt. % of a lipase enzyme.

Preferably the lipase belongs to the enzyme class EC 3.1.1.3.

Preferably the lipase is bacterial or fungal in origin, more preferably the lipase is fungal in origin.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) or from H. insolens, a Pseudomonas lipase, e.g. from P. alcaligenes or P. pseudoalcaligenes, P. cepacia, P. stutzeri, P. fluorescens, Pseudomonas sp. strain SD 705, P. wisconsinensis, a Bacillus lipase, e.g. from B. subtilis (Dartois et al. (1993), Biochemica et Biophysica Acta, 1131, 253-360), B. stearothermophilus or B. pumilus.

Preferred commercially available lipase enzymes include Lipolase™ and Lipolase Ultra™′ Lipex™ and Lipoclean™ (Novozymes A/S).

Saponin

The composition comprises from 0.25 to 40 wt. %, preferably from 0.5 to 30 wt. %, more preferably from 0.5 to 25 wt. %, more preferably from 1 to 20 wt. %, most preferably from 1 to 15 wt. %, of a saponin.

Saponins are natural compounds which contain sugar moieties bound to a fused system of non-aromatic 4, 5 and 6 membered rings. The ring system are preferably selected from the groups of triterpenoids, for example lanostane, dammarane, lupane, oleanane, ursane and hopane. An overview of these ring systems is provided in Natural Product Reports 27 (2010), 79-132 by R. A. Hill et al.

Saponins are discussed in “Saponins Used in Food and Agriculture” Plenum Press, New York 1996, G. R. Waller and K. Yamasaki (eds).

Saponins are preferably extracted from the seed, root, leaf, bulb, fruit, stem, pericarp, bark, tuber or flower of a plant. Saponin extraction and quantification is discussed in Food Research International 59 (2014) 16-40 by R. Sulaiman ey al. Extraction of saponins from agricultural products is discussed in WO2017/019599 and WO1999/053933.

Saponins may also be produced by bacteria (for example glycosylated hopanoids such as ribosylhopane) and marine organisms including sea cucumbers, starfish and sponges (Bahrami, Y., Zhang, W. & Franco, C. M. (2018) Marine Drugs 16: 423-453). Saponins may also be produced through biotechnology, either through enzymatic biosynthesis in vitro or by the engineering of microbial cell factories (Moses, T. et al. (2014) PNAS 28:1634-1639).

The saponin is preferably a Tea saponin (for example preferably derived from Camellia species), Soapnut saponin (for example preferably derived from Sapindus species), Quillaja Bark saponin or Escin (for example preferably derived from Aesculus species).

Preferably the saponin has a structure comprising a triterpenoid backbone and one or more sugar moieties attached to the triterpenoid backbone.

Saponins are listed in the Chemical Entities of Biological Interest (ChEBI) database, (Hastings, J., de Matos, P., Dekker, A., Ennis, M., Harsha, B., Kale, N., Muthukrishnan, V., Owen, G., Turner, S., Williams, M., and Steinbeck, C. (2013) The ChEBI reference database and ontology for biologically relevant chemistry: enhancements for 2013. Nucleic Acids Res.). For example, CHEBI:61778-triterpenoid saponin.

Agricultural residues remaining after harvest may be suitable for extraction and supply of saponins. For example, sugarbeet leaves and skins may be further extracted to derive useful quantities of saponin. In China, the production and supply of tea saponin derived from the seed cake remaining after extraction of Camellia oleifera seeds for tea seed oil is well established. Alternatively, saponins may be extracted from parts of the plant collected from the wild (for example, protodioscin from Tribulus terrestris) or through managed plantations (for example from the bark of Quillaja saponaria).

Preferred Ingredients

Surfactant The detergent composition preferably comprises surfactant (which includes a mixture of two or more surfactants). The composition comprises from 1 to 60 wt. %, preferably from 2.5 to 50 wt. %, more preferably from 4 to 40 wt. % of surfactant. Even more preferred levels of surfactant are from 6 to 40 wt. %, more preferably from 8 to 35 wt. %.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher alkyl radicals.

Examples of suitable anionic detergent compounds are rhamnolipids, sodium and potassium alkyl sulphates, especially those obtained by sulphating higher C₈ to C₁₈ alcohols, produced for example from tallow or coconut oil, sodium and potassium alkyl C₉ to C₂₀ benzene sulphonates, particularly sodium linear secondary alkyl C₁₀ to C₁₅ benzene sulphonates; and sodium alkyl glyceryl ether sulphates, especially those ethers of the higher alcohols derived from tallow or coconut oil and synthetic alcohols derived from petroleum.

The anionic surfactant is preferably selected from: rhamnolipids, linear alkyl benzene sulphonate; alkyl sulphates; alkyl ether sulphates; soaps; alkyl (preferably methyl) ester sulphonates, and mixtures thereof.

The most preferred anionic surfactants are selected from: rhamnolipids, linear alkyl benzene sulphonate; alkyl sulphates; alkyl ether sulphates and mixtures thereof. Preferably the alkyl ether sulphate is a C₁₂-C₁₄ n-alkyl ether sulphate with an average of 1 to 3EO (ethoxylate) units.

Sodium lauryl ether sulphate is particularly preferred (SLES). Preferably the linear alkyl benzene sulphonate is a sodium C₁₁ to C₁₅ alkyl benzene sulphonates. Preferably the alkyl sulphates is a linear or branched sodium C₁₂ to C₁₈ alkyl sulphates. Sodium dodecyl sulphate is particularly preferred, (SDS, also known as primary alkyl sulphate). Rhamnolipids may preferably be be mono-rhamnolipid rich (over 60%), di-rhamnolipid rich (over 60%), or a 40/60 to 60-40 mixture of mono- and di-rhamnolipid.

In liquid formulations preferably two or more anionic surfactant are present, for example linear alkyl benzene sulphonate together with an alkyl ether sulphate.

In liquid formulations, preferably the laundry composition in addition to the anionic surfactant comprises alkyl exthoylated non-ionic surfactant, preferably from 2 to 8 wt. % of alkyl ethoxylated non-ionic surfactant.

Suitable nonionic detergent compounds which may be used include, in particular, the reaction products of compounds having an aliphatic hydrophobic group and a reactive hydrogen atom, for example, aliphatic alcohols, acids or amides, especially ethylene oxide either alone or with propylene oxide. Preferred nonionic detergent compounds are the condensation products of aliphatic C₈ to C₁₈ primary or secondary linear or branched alcohols with ethylene oxide. Alkyl polyglycosides (APG) are also preferred.

Most preferably the nonionic detergent compound is the alkyl ethoxylated non-ionic surfactant is a C₈ to C₁₈ primary alcohol with an average ethoxylation of 7EO to 9EO units.

Preferably the surfactants used are saturated.

Soil Release Polymer

It is preferred that a soil release polymer is included.

The laundry detergent composition preferably comprises from 0.1 to 8 wt. % of a soil release polymer.

Preferred levels of soil release polymer range from 0.2 to 6 wt. %, more preferably from 0.5 to 5 wt. %, most preferably from 1 to 5 wt. %.

Preferably the soil release polymer is a polyester soil release polymer.

More preferably the polyester soil release polymer is a polyethylene and/or polypropylene terephthalate based soil release polymer, most preferably a polypropylene terephthalate based soil release polymer.

Suitable polyester based soil release polymers are described in WO 2014/029479 and WO 2016/005338.

Alkoxylated Polyamine

When the detergent composition is in the form of a laundry composition, it is preferred that an alkoxylated polyamine is included.

The laundry detergent preferably comprises from 0.1 to 8 wt. % of an alkoxylated polyamine.

Preferred levels of alkoxylated polyamine range from 0.2 to 6 wt. %, more preferably from 0.5 to 5 wt. %. Another preferred level is from 1 to 4 wt. %.

The alkoxylated polyamine may be linear or branched. It may be branched to the extent that it is a dendrimer. The alkoxylation may typically be ethoxylation or propoxylation, or a mixture of both. Preferably the alkoxylated polyamine comprises an alkoxylated polyethylenimine, and/or alkoxylated polypropylenimine, more preferably the alkoxylation is ethoxylation or propoxylation or a mixture of both. Where a nitrogen atom is alkoxylated, a preferred average degree of alkoxylation is from 10 to 30, preferably from 15 to 25.

A preferred material is alkoxylated polyethylenimine, most preferably ethoxylated polyethyleneimine, with an average degree of ethoxylation being from 10 to 30 preferably from 15 to 25, where a nitrogen atom is ethoxylated.

Additional Enzymes

Additional enzymes, other than the required lipase may be present in the cleaning composition. It is preferred that additional enzymes other than lipase are present in the preferred laundry detergent composition.

If present, then the level of each additional enzyme in the composition of the invention is from 0.0001 wt. % to 0.1 wt. %.

Levels of enzyme present in the composition preferably relate to the level of enzyme as pure protein.

Preferred enzymes include those in the group consisting of: proteases, cellulases, alpha-amylases, peroxidases/oxidases, pectate lyases, and/or mannanases. Said preferred enzymes include a mixture of two or more of these enzymes.

Preferably the enzyme is selected from: proteases, cellulases, and/or alpha-amylases.

Preferred proteases are selected from the following group, serine, acidic, metallo- and cysteine proteases. More preferably the protease is a serine and/or acidic protease.

Preferably the protease is a serine protease. More preferably the serine protease is subtilisin type serine protease.

Protease enzymes hydrolyse bonds within peptides and proteins, in the cleaning context this leads to enhanced removal of protein or peptide containing stains. Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus species such as Bacillus lentus, B. licheniformis, B. alkalophilus, B. subtilis, B. amyloliquefaciens, B. pumilus and B. gibsonii, and subtilisin lentus, subtilisin Novo, subtilisin Carlsberg, subtilisin BPN′, subtilisin 309, subtilisin 147 and subtilisin 168, and protease PD138. Examples of trypsin-like proteases are trypsin (e.g. of porcine or bovine origin) and the Fusarium protease, and the chymotrypsin proteases derived from Cellumonas.

Most preferably the protease is a subtilisin protease (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii, and subtilisin lentus, subtilisin Novo, subtilisin Carlsberg, Bacillus licheniformis, subtilisin BPN′, subtilisin 309, subtilisin 147 and subtilisin 168 and protease PD138. Preferably the subsilisin is derived from Bacillus, preferably Bacillus lentus, B. alkalophilus, B. subtilis, B. amyloliquefaciens, Bacillus pumilus and Bacillus gibsonii. Most preferably the subtilisin is derived from Bacillus gibsonii or Bacillus Lentus.

Suitable commercially available protease enzymes include those sold under the trade names names Carnival®, Relase®, Relase® Ultra, Savinase®, Savinase® Ultra, Coronase®, Coronase® Ultra, Kannase®, Liquanase®, Liquanase® Ultra, all could be sold as Ultra® or Evity® (Novozymes A/S).

The invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol.

Phospholipases are enzymes which participate in the hydrolysis of phospholipids. Several types of phospholipase activity can be distinguished, including phospholipases A1 and A2 which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

The composition may use cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™, Termamyl™, Termamyl Ultra™, Natalase™, Stainzyme™, Amplify™, Fungamyl™ and BAN™ (Novozymes A/S), Rapidase™ and Purastar™ (from Genencor International Inc.).

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum. Commercially available cellulases include Celluzyme™, Carezyme™, Celluclean™, Endolase™, Renozyme™ (Novozymes A/S), Clazinase™ and Puradax HA™ (Genencor International Inc.), and KAC-500(B)™ (Kao Corporation). Celluclean™ is preferred.

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof. Commercially available peroxidases include Guardzyme™ and Novozym™ 51004 (Novozymes A/S).

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Further Materials

Further optional but preferred materials that may be included in the detergent compositions (preferably laundry detergent compositions) include builders, chelating agents, fluorescent agent, perfume, shading dyes and polymers.

Builders or Complexing Agents

The composition may comprise a builder.

Builder materials may be selected from 1) calcium sequestrant materials, 2) precipitating materials, 3) calcium ion-exchange materials and 4) mixtures thereof.

Examples of calcium sequestrant builder materials include alkali metal polyphosphates, such as sodium tripolyphosphate and organic sequestrants, such as ethylene diamine tetra-acetic acid.

Examples of precipitating builder materials include sodium orthophosphate and sodium carbonate.

Examples of calcium ion-exchange builder materials include the various types of water-insoluble crystalline or amorphous aluminosilicates, of which zeolites are well known representatives thereof, e.g. zeolite A, zeolite B (also known as zeolite P), zeolite C, zeolite X, zeolite Y and also the zeolite P-type as described in EP-A-0,384,070.

The composition may also contain 0-65 wt. % of a builder or complexing agent such as ethylenediaminetetraacetic acid, diethylenetriamine-pentaacetic acid, alkyl- or alkenylsuccinic acid, nitrilotriacetic acid or the other builders mentioned below. Many builders are also bleach-stabilising agents by virtue of their ability to complex metal ions.

Zeolite and carbonate (carbonate (including bicarbonate and sesquicarbonate) are preferred builders, with carbonates being particularly preferred.

The composition may contain as builder a crystalline aluminosilicate, preferably an alkali metal aluminosilicate, more preferably a sodium aluminosilicate. This is typically present at a level of less than 15 wt. %.

Aluminosilicates are materials having the general formula:

0.8−1.5M₂O.Al₂C₃.0.8−6SiO₂,

where M is a monovalent cation, preferably sodium.

These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Alternatively, or additionally to the aluminosilicate builders, phosphate builders may be used. In this art the term ‘phosphate’ embraces diphosphate, triphosphate, and phosphonate species. Other forms of builder include silicates, such as soluble silicates, metasilicates, layered silicates (e.g. SKS-6 from Hoechst).

If a laundry detergent, then preferably the laundry detergent formulation is a non-phosphate built laundry detergent formulation, i.e., contains less than 1 wt. % of phosphate. Most preferably the laundry detergent formulation is not built i.e. contain less than 1 wt. % of builder.

Chelating Agent

Chelating agents may be present or absent from the detergent compositions.

If present, then the chelating agent is present at a level of from 0.01 to 5 wt. %.

Example phosphonic acid (or salt thereof) chelating agents are: 1-Hydroxyethylidene-1,1-diphosphonic acid (HEDP); Diethylenetriaminepenta(methylenephosphonic acid) (DTPMP);

Hexamethylenediaminetetra(methylenephosphonic acid) (HDTMP); Aminotris(methylenephosphonic acid) (ATMP); Ethylenediaminetetra(methylenephosphonic acid) (EDTMP); Tetramethylenediaminetetra(methylenephosphonic acid) (TDTMP); and, Phosphonobutanetricarboxylic acid (PBTC).

Fluorescent Agent

The composition preferably comprises a fluorescent agent (optical brightener). Fluorescent agents are well known, and many such fluorescent agents are available commercially. Usually, these fluorescent agents are supplied and used in the form of their alkali metal salts, for example, the sodium salts.

The total amount of the fluorescent agent or agents used in the composition is generally from 0.0001 to 0.5 wt. %, preferably 0.005 to 2 wt. %, more preferably 0.01 to 0.1 wt. %.

Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN.

Preferred fluorescers are fluorescers with CAS-No 3426-43-5; CAS-No 35632-99-6; CAS-No 24565-13-7; CAS-No 12224-16-7; CAS-No 13863-31-5; CAS-No 4193-55-9; CAS-No 16090-02-1; CAS-No 133-66-4; CAS-No 68444-86-0; CAS-No 27344-41-8.

Most preferred fluorescers are: sodium 2 (4-styryl-3-sulfophenyl)-2H-napthol[1,2-d]triazole, disodium 4,4′-bis{[(4-anilino-6—(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]amino} stilbene-2-2′ disulphonate, and disodium 4,4′-bis(2-sulphostyryl)biphenyl.

The aqueous solution used in the method has a fluorescer present. The fluorescer is present in the aqueous solution used in the method preferably in the range from 0.0001 g/I to 0.1 g/I, more preferably 0.001 to 0.02 g/I.

Perfume

The composition preferably comprises a perfume. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

Preferably the perfume comprises at least one note (compound) from: alpha-isomethyl ionone, benzyl salicylate; citronellol; coumarin; hexyl cinnamal; linalool; pentanoic acid, 2-methyl-, ethyl ester; octanal; benzyl acetate; 1,6-octadien-3-ol, 3,7-dimethyl-, 3-acetate; cyclohexanol, 2-(1,1-dimethylethyl)-, 1-acetate; delta-damascone; beta-ionone; verdyl acetate; dodecanal; hexyl cinnamic aldehyde; cyclopentadecanolide; benzeneacetic acid, 2-phenylethyl ester; amyl salicylate; beta-caryophyllene; ethyl undecylenate; geranyl anthranilate; alpha-irone; beta-phenyl ethyl benzoate; alpa-santalol; cedrol; cedryl acetate; cedry formate; cyclohexyl salicyate; gamma-dodecalactone; and, beta phenylethyl phenyl acetate.

Useful components of the perfume include materials of both natural and synthetic origin. They include single compounds and mixtures. Specific examples of such components may be found in the current literature, e.g., in Fenaroli's Handbook of Flavour Ingredients, 1975, CRC Press; Synthetic Food Adjuncts, 1947 by M. B. Jacobs, edited by Van Nostrand; or Perfume and Flavour Chemicals by S. Arctander 1969, Montclair, N.J. (USA).

It is commonplace for a plurality of perfume components to be present in a formulation. In the compositions of the present invention it is envisaged that there will be four or more, preferably five or more, more preferably six or more or even seven or more different perfume components.

In perfume mixtures preferably 15 to 25 wt % are top notes. Top notes are defined by Poucher (Journal of the Society of Cosmetic Chemists 6(2):80 [1955]). Preferred top-notes are selected from citrus oils, linalool, linalyl acetate, lavender, dihydromyrcenol, rose oxide and cis-3-hexanol.

The International Fragrance Association has published a list of fragrance ingredients (perfumes) in 2011. (http://www.ifraorq.orgilen-us/ingiredients#.U7Z4hPldWzk)

The Research Institute for Fragrance Materials provides a database of perfumes (fragrances) with safety information.

Perfume top note may be used to cue the whiteness and brightness benefit of the invention.

Some or all of the perfume may be encapsulated, typical perfume components which it is advantageous to encapsulate, include those with a relatively low boiling point, preferably those with a boiling point of less than 300, preferably 100-250 Celsius. It is also advantageous to encapsulate perfume components which have a low CLog P (ie. those which will have a greater tendency to be partitioned into water), preferably with a CLog P of less than 3.0. These materials, of relatively low boiling point and relatively low CLog P have been called the “delayed blooming” perfume ingredients and include one or more of the following materials: allyl caproate, amyl acetate, amyl propionate, anisic aldehyde, anisole, benzaldehyde, benzyl acetate, benzyl acetone, benzyl alcohol, benzyl formate, benzyl iso valerate, benzyl propionate, beta gamma hexenol, camphor gum, laevo-carvone, d-carvone, cinnamic alcohol, cinamyl formate, cis-jasmone, cis-3-hexenyl acetate, cuminic alcohol, cyclal c, dimethyl benzyl carbinol, dimethyl benzyl carbinol acetate, ethyl acetate, ethyl aceto acetate, ethyl amyl ketone, ethyl benzoate, ethyl butyrate, ethyl hexyl ketone, ethyl phenyl acetate, eucalyptol, eugenol, fenchyl acetate, flor acetate (tricyclo decenyl acetate), frutene (tricycico decenyl propionate), geraniol, hexenol, hexenyl acetate, hexyl acetate, hexyl formate, hydratropic alcohol, hydroxycitronellal, indone, isoamyl alcohol, iso menthone, isopulegyl acetate, isoquinolone, ligustral, linalool, linalool oxide, linalyl formate, menthone, menthyl acetphenone, methyl amyl ketone, methyl anthranilate, methyl benzoate, methyl benyl acetate, methyl eugenol, methyl heptenone, methyl heptine carbonate, methyl heptyl ketone, methyl hexyl ketone, methyl phenyl carbinyl acetate, methyl salicylate, methyl-n-methyl anthranilate, nerol, octalactone, octyl alcohol, p-cresol, p-cresol methyl ether, p-methoxy acetophenone, p-methyl acetophenone, phenoxy ethanol, phenyl acetaldehyde, phenyl ethyl acetate, phenyl ethyl alcohol, phenyl ethyl dimethyl carbinol, prenyl acetate, propyl bornate, pulegone, rose oxide, safrole, 4-terpinenol, alpha-terpinenol, and/or viridine. It is commonplace for a plurality of perfume components to be present in a formulation. In the compositions of the present invention it is envisaged that there will be four or more, preferably five or more, more preferably six or more or even seven or more different perfume components from the list given of delayed blooming perfumes given above present in the perfume.

Another group of perfumes with which the present invention can be applied are the so-called ‘aromatherapy’ materials. These include many components also used in perfumery, including components of essential oils such as Clary Sage, Eucalyptus, Geranium,

Lavender, Mace Extract, Neroli, Nutmeg, Spearmint, Sweet Violet Leaf and Valerian.

It is preferred that the laundry treatment composition does not contain a peroxygen bleach, e.g., sodium percarbonate, sodium perborate, and peracid.

Shading Dye

Preferably when the composition is a laundry detergent composition, then it comprises a shading dye. Preferably the shading dye is present at from 0.0001 to 0.1 wt. % of the composition.

Dyes are described in Color Chemistry Synthesis, Properties and Applications of Organic Dyes and Pigments, (H Zollinger, Wiley VCH, Zurich, 2003) and, Industrial Dyes Chemistry, Properties Applications. (K Hunger (ed), Wiley-VCH Weinheim 2003).

Shading Dyes for use in laundry compositions preferably have an extinction coefficient at the maximum absorption in the visible range (400 to 700 nm) of greater than 5000 L mol⁻¹ cm⁻¹, preferably greater than 10000 L mol⁻¹ cm⁻¹. The dyes are blue or violet in colour.

Preferred shading dye chromophores are azo, azine, anthraquinone, and triphenylmethane.

Azo, anthraquinone, phthalocyanine and triphenylmethane dyes preferably carry a net anionic charged or are uncharged. Azine preferably carry a net anionic or cationic charge. Blue or violet shading dyes deposit to fabric during the wash or rinse step of the washing process providing a visible hue to the fabric. In this regard the dye gives a blue or violet colour to a white cloth with a hue angle of 240 to 345, more preferably 250 to 320, most preferably 250 to 280. The white cloth used in this test is bleached non-mercerised woven cotton sheeting.

Shading dyes are discussed in WO 2005/003274, WO 2006/032327(Unilever), WO 2006/032397(Unilever), WO 2006/045275(Unilever), WO 2006/027086(Unilever), WO 2008/017570(Unilever), WO 2008/141880 (Unilever), WO 2009/132870(Unilever), WO 2009/141173 (Unilever), WO 2010/099997(Unilever), WO 2010/102861(Unilever), WO 2010/148624(Unilever), WO 2008/087497 (P&G), WO 2011/011799 (P&G), WO 2012/054820 (P&G), WO 2013/142495 (P&G) and WO 2013/151970 (P&G).

Mono-azo dyes preferably contain a heterocyclic ring and are most preferably thiophene dyes. The mono-azo dyes are preferably alkoxylated and are preferably uncharged or anionically charged at pH=7. Alkoxylated thiophene dyes are discussed in WO/2013/142495 and WO/2008/087497. Preferred examples of thiophene dyes are shown below:

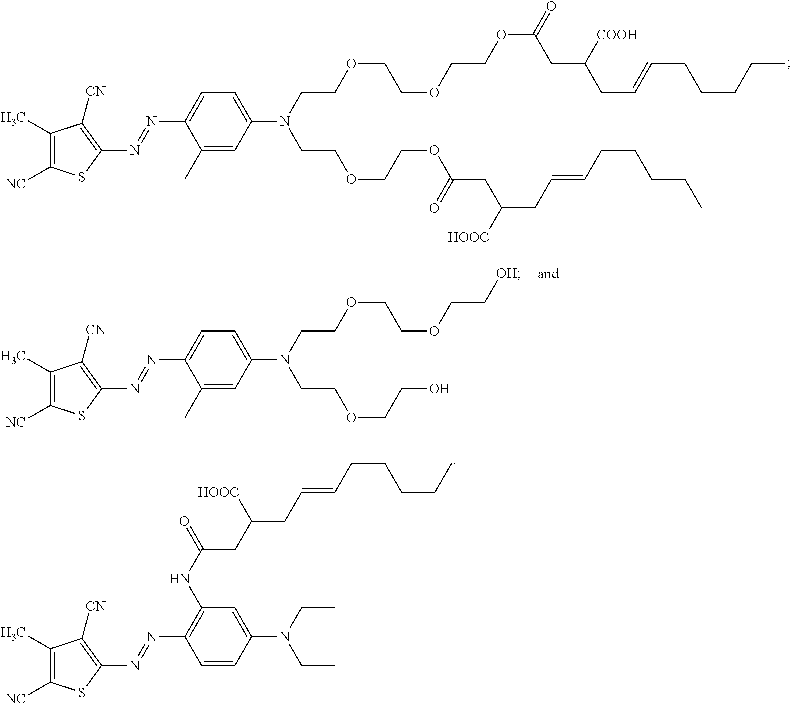

Bis-azo dyes are preferably sulphonated bis-azo dyes. Preferred examples of sulphonated bis-azo compounds are direct violet 7, direct violet 9, direct violet 11, direct violet 26, direct violet 31, direct violet 35, direct violet 40, direct violet 41, direct violet 51, Direct Violet 66, direct violet 99 and alkoxylated versions thereof. Alkoxylated bis-azo dyes are discussed in WO2012/054058 and WO2010/151906.

An example of an alkoxylated bis-azo dye is:

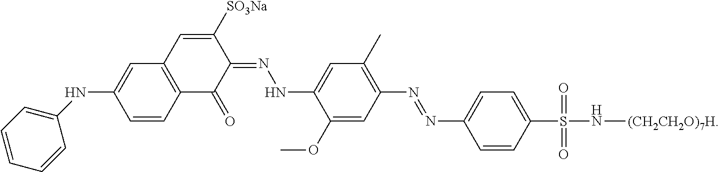

Thiophene dyes are available from Milliken under the tradenames of Liquitint Violet DD and

Liquitint Violet ION.

Azine dye are preferably selected from sulphonated phenazine dyes and cationic phenazine dyes. Preferred examples are acid blue 98, acid violet 50, dye with CAS-No 72749-80-5, acid blue 59, and the phenazine dye selected from:

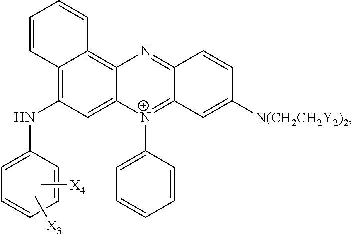

wherein:

X₃ is selected from: —H; —F; —CH₃; —C₂H₅; —OCH₃; and, —OC₂H₅;

X₄ is selected from: —H; —CH₃; —C₂H₅; —OCH₃; and, —OC₂H₅;

Y₂ is selected from: —OH; —OCH₂CH₂OH; —CH(OH)CH₂OH; —OC(O)CH₃; and, C(O)OCH₃.

The shading dye is present is present in the composition in range from 0.0001 to 0.5 wt %, preferably 0.001 to 0.1 wt %. Depending upon the nature of the shading dye there are preferred ranges depending upon the efficacy of the shading dye which is dependent on class and particular efficacy within any particular class. As stated above the shading dye is a blue or violet shading dye.

A mixture of shading dyes may be used.

The shading dye is most preferably a reactive blue anthraquinone dye covalently linked to an alkoxylated polyethyleneimine. The alkoxylation is preferably selected from ethoxylation and propoxylation, most preferably propoxylation. Preferably 80 to 95 mol % of the N—H groups in the polyethylene imine are replaced with iso-propyl alcohol groups by propoxylation. Preferably the polyethylene imine before reaction with the dye and the propoxylation has a molecular weight of 600 to 1800.

An example structure of a preferred reactive anthraquinone covalently attached to a propoxylated polyethylene imine is:

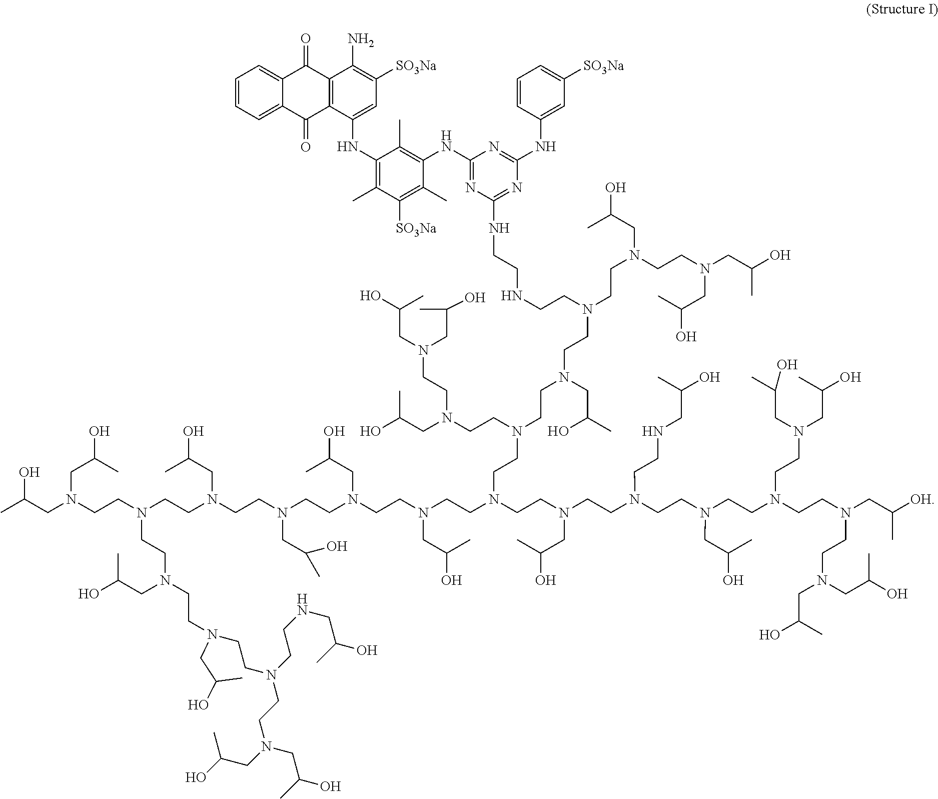

Polymers

The composition may comprise one or more further polymers. A preferred detergent composition comprises from 0.1 to 20 wt. %, preferably from 0.5 to 15 wt. % or one or more polymers. Examples are carboxymethylcellulose, poly (ethylene glycol), poly(vinyl alcohol), polycarboxylates such as polyacrylates, maleic/acrylic acid copolymers and lauryl methacrylate/acrylic acid copolymers.

### EXAMPLES

The invention will be demonstrated by the following non-limiting examples.

Experimental Methods:

Determination of Protein Concentration

The total amount of protein of enzyme samples was estimated by using Sigma-Aldrich (bicinchoninic acid) BCA assay kit and the working reagent was prepared as instructed in the user's manual. BCA reagent was prepared by mixing solution A [1% (w/v) bicinchoninic acid in sodium salt form, 2% (w/v) sodium carbonate, 0.16% (w/v) sodium tartrate, 0.4% (w/v) sodium hydroxide, 0.95% (w/v) sodium hydrogen carbonate, pH 11.5] with solution B [4% (w/v) copper sulphate] at 50:1 (v/v) ratio. A serial dilution of bovine serum albumin (2 mg/mL) was carried out in deionised water to create 7 points of a standard curve. To perform the assay, BCA reagent (200 μL) was added into the wells of 96-well plate, followed by sample protein dilutions (20 μL). The microtitre plates (MTP) were sealed and incubated at 37° C. for 30 min. After incubation, the absorbance at 540 nm was measured on a spectrophotometer.

Biochemical Determination of Lipase Activity

Lipase activity was determined by a colorimetric method using 4-nitrophenyl-valerate (C₅) and 4-nitrophenyl-dodecanoate (C₁₂) as substrates. 4-nitrophenyl-dodecanoate (25 mg) or 4-nitrophenyl-valerate (18 mg) were dissolved in 10 mL solvent (methanol) to prepare 8 mM stock solutions. 1 mL of stock solution was added in 7 mL of acidified water (pH 4.5), to give a final concentration of 1 mM (the substrate). In 96-well microtitre plates the following reagents were added: 60 μL dH2O, 80 μL Tris-HCl buffer (pH 8.5, 50 mM), 20 μL of diluted enzyme solution, 20 μL of saponin 10× concentrated stock solution. 20 μL substrate was then added to start the reaction. For zero enzyme controls, enzyme solution was replaced with H₂O. Following the addition of substrate, the release of product (4-nitrophenol) was monitored at 405 nm for 15 min at ambient temperature in a Varioskan plate reader.

Microtitre-Plate Cleaning Methodology

Woven cotton fabric stained with beef fat (CS61) (Centre for Testmaterials-Netherlands) was cut into empty 96-well microtitre plates and pre-wash readings taken for stain intensity.

Lipase/saponin wash solutions were prepared in FH32 water, and subsequently transferred (200 μL) to the stains using a multi-channel pipette just prior to incubation at 30° C., with shaking at 200 rpm for 30 min. Following washing, the wash liquor was immediately removed using a multi-channel pipette, and the stain discs washed 3× with 200 μL dH2O, before leaving overnight in a cupboard to dry. After drying, the stain plates were digitally scanned and their deltaE measured. This value is used to express cleaning effect and is defined as the colour difference between a white cloth and that of the stained cloth after being washed. Mathematically, the definition of deltaE is:

deltaE=[(ΔL)2+(Δa)2+(Δb)2]1/2

wherein ΔL is a measure of the difference in darkness between the washed and white cloth; Δa and Δb are measures for the difference in redness and yellowness respectively between both cloths. From this equation, it is clear that the lower the value of deltaE, the whiter the cloth will be. With regard to this colour measurement technique, reference is made to Commission International de l'Eclairage (CIE); Recommendation on Uniform Colour Spaces, colour difference equations, psychometric colour terms, supplement no. 2 to CIE Publication, no. 15, Colorimetry, Bureau Central de la CIE, Paris 1978.

Herein the cleaning effect is expressed in the form of a stain removal index (SRI):

SRI=100−deltaE.

The higher the SRI the cleaner the cloth, SRI=100 (white).

Tergotometer Experiments:

The cleaning performance of saponin containing formulations was determined by washing standard stain swatches in a tergotometer. Water hardness was 13 FH or 26 FH. Wash time was 30 minutes followed by three rinses in water of the same hardness as the wash liquor. Wash temperature was 25° C.

The stain swatch was woven cotton comprising a lard, stain. Measurements of the optical absorbance of each stain were taken using a spectrophotometer before and after washing to get a value for deltaE. The resultant SRI was calculated using the same procedure as for the microtitre plate assays.

Biochemical Determination of Esterase Activity

Same method as for determination of lipase activity was applied with use of a C₄-pNP ester substrate (4-nitrophenyl-butyrate) instead.

Materials Used

| Surfactants | Source |
|---|---|
| LAS ACID (EU) (97%) | Unilever Supply |
| | chain company AG |
| SLES-3EO (Texapon N703) | BASF |
| Neodol 25-7 | Croda |
| Saponins and Terpenoids | |
| Escin (96%) | Sigma-Aldrich |
| | catalogue no. E1378 |
| Tea saponin (98%) | Nanjing Zelang Medical |
| | Technology Co. Ltd. |
| Glycyrrhizic acid (95%) | Sigma Aldrich |
| | catalogue no. 50531 |
| Quillaja bark | Sigma Aldrich |
| saponin (25-30%) | catalogue no. S4521 |
| Avenacin (87.9%) | Gift from John Innes |
| | Centre, Norwich, UK |
| Oleanolic acid (97%) | Sigma Aldrich |
| | catalogue no. O5504 |
| Oleanolic acid-O-28- | Gift from John Innes |
| triglucoside (74.6) | Centre, Norwich, UK |
| Oleanolic acid-O-28- | Gift from John Innes |
| tetraglucoside (80.7) | Centre, Norwich, UK |
| Enzymes | |
| Lipex 100 L | Novozymes |
| Lipex Evity | Novozymes |
| Resinase HT | Novozymes |
| Novozyme 51032 | Novozymes |

### Example 1 Biochemical Experiment Showing Escin Saponin Activating Lipases

The dose response of various lipases to saponins were tested in a biochemical assay. The concentration of lipase in these experiments was 10 μg/L. This level was chosen to ensure that substrate hydrolysis and resultant increase in absorbance measurements falls within the sensitivity of the spectrophotometer. Table 1 shows the percentage increase in enzyme activity of a selection of lipases to inclusion and increasing concentration of escin. In all cases, the lipase activity increased as the escin concentration reached above a threshold value, which varied according to the enzyme in question, but was in the region 0.01 (Resinase HT) to 0.10 μM (Lipex, 100 L, Lipex Evity and Novozyme 51032). Enzyme activity also increased with further escin concentration above this value up to the maximum concentration tested.

TABLE 1
Percentage (%) increase in lipase activity in the presence of increasing
concentrations of escin compared to absence of saponin

| | % increase in Lipase activity in the presence | | | |
|---|---|---|---|---|
| | of escin saponin compared to absence of saponin | | | |
| Saponin | Lipex | Lipex | Resinase | Novozym |
| dose (μM) | 100L | Evity | HT | 51032 |
| 0 | 0 | 0 | 0 | 0 |
| 0.01 | −25 | 0 | 70 | 0 |
| 0.1 | 25 | 20 | 60 | 50 |
| 0.5 | 100 | 120 | 170 | 50 |
| 1 | 450 | 200 | 210 | 50 |
| 2.5 | 1650 | 240 | 140 | 150 |
| 5 | 1775 | 260 | 200 | 250 |

### Example 2 Biochemical Experiment Showing the Essentiality of the Triterpenoid Backbone and One or More Sugar Moieties to Give Good Activation of Lipase

Activation of a single lipase (Lipex 100 L) by a variety of natural saponins and saponins derived through metabolic engineering were tested using the biochemical assay. The unglycosylated terpenoid, oleanolic acid (OA), was also tested to determine whether lipase activation was a result of the terpenoid moiety or required the terpenoid scaffold to be glycosylated. To compare this directly, the enzymes activation by saponins comprising oleanolic acid glycosylated with 3 or 4 glycoside residues at the C28 position of the triterpenoid (oleanolic acid-28-O-triglycoside (OA-28 x3Gly) and oleanolic acid-28-O-tetraglycoside (OA-28 x4Gly), were compared directly to the activation achieved by oleanolic acid.

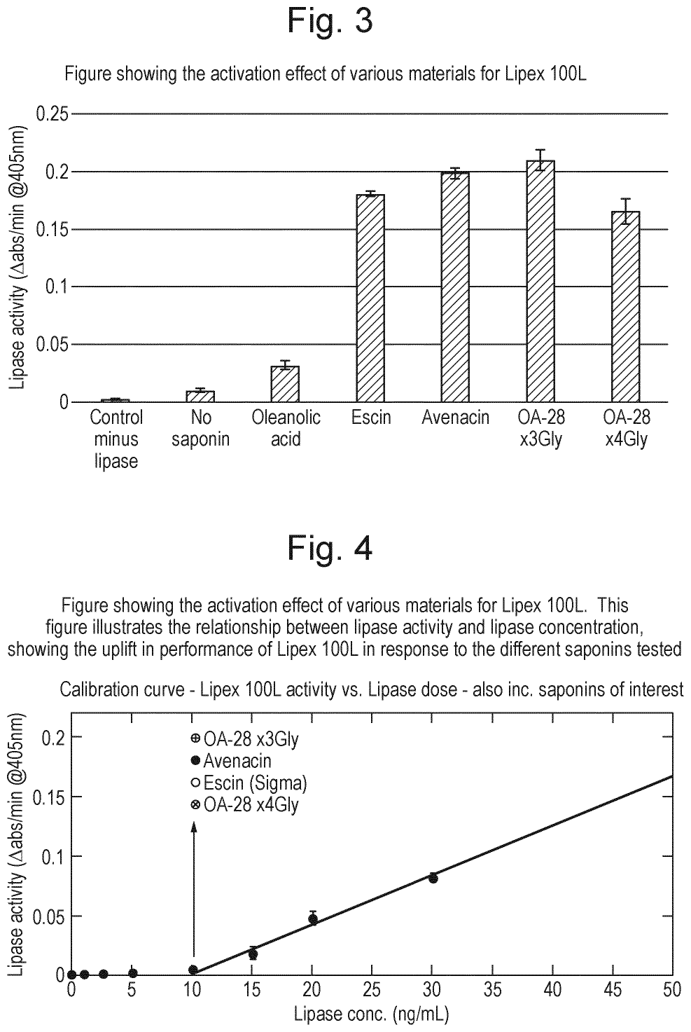

FIG. 3 shows that, as anticipated from Example 1, all saponins tested at 10 μM (escin, avenacin, OA-28 x3Gly and OA-28 x4Gly) activate Lipex 100 L. Whilst oleanolic acid does have small activation towards the lipase, this is significantly less than the activation achieved by the saponins which is greater than 15-fold activation for all saponins, and maximally greater than 20-fold for OA-28 x3Gly. We can therefore conclude that whilst the terpenoid scaffold is required for activation, the presence of the sugar residues on the scaffold are required for significant and commercially relevant activation of lipase.

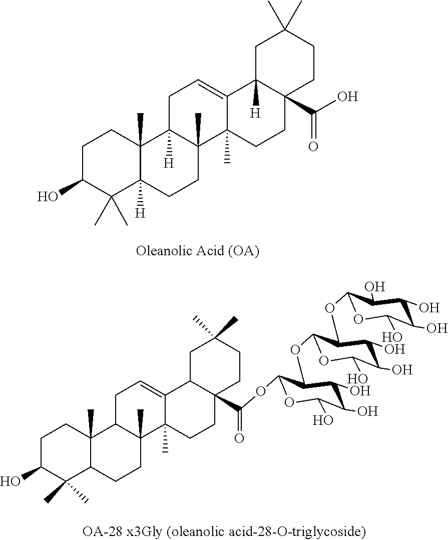

FIG. 4 expresses the same data as FIG. 3, but this time superimposed on a plot of Lipex 100 L activity vs. concentration. This clearly shows that 10 μM of a saponin can have the same impact on lipase activity as increasing the lipase concentration from 10 to 50 ng/ml. Given enzymes are typically the most expensive ingredient in a laundry formulation, the inclusion of saponin could significantly decrease the amount of enzyme required and hence reduce the total raw material cost of the formulation.

### Example 3 Cleaning Studies Showing the Effect of Saponin in Formulations

The effect of substituting 30% or 10% of the surfactant composition of a laundry detergent with escin saponin in the presence and absence of lipase at 25° C. was demonstrated in a tergotometer experiment.

Two Surfactant Blends were Studied:

1. 70% LAS, 15% SLES and 15% Neodol 25-7 (70/15/15)

2. 85% LAS and 15% SLES (85/15/0) Total surfactant in use concentration was 0.58 g/L.

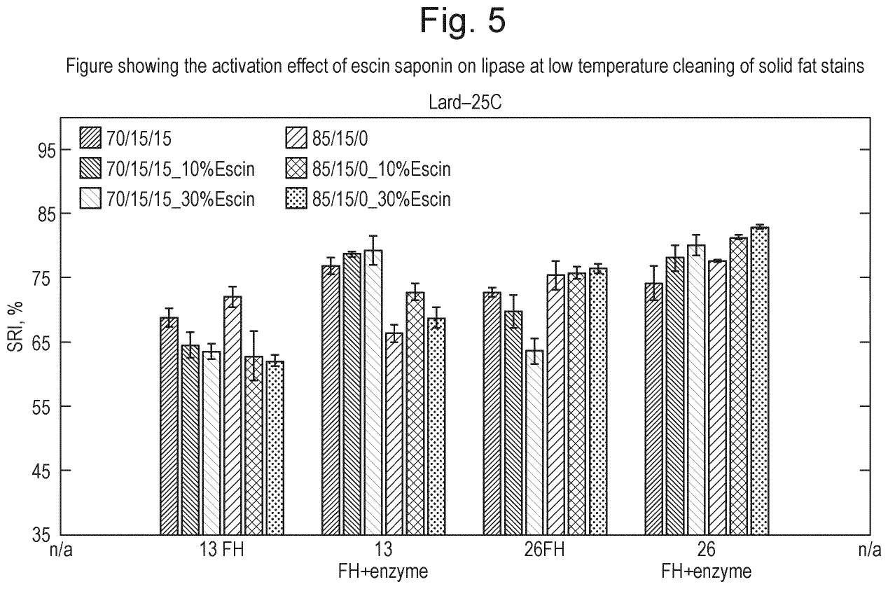

Tergotometer experiments were run at two water hardnesses and with and without Lipex 100 L at 25 mg/L. Cleaning performance was monitored on a lard/crystal violet stain (test cloth from CFT) on woven cotton. The results are shown in FIG. 5.

FIG. 5 shows that in the absence of enzyme, escin has a deleterious effect on cleaning. In the presence of lipase however, the saponin-containing formulations consistently out-perform the formulations without saponin.

This conclusively shows that the saponin is activating the lipase, as the saponin on its own in the formulation (without lipase) gives a slightly negative effect to the cleaning. This example shows the effect at formulation level. In this example, effective activation of lipase by saponin is demonstrated at an in-use saponin concentration of 0.0058% to 0.0174%, equivalent to an in-product concentration of between 5.8 wt. % and 17.4 wt. %.

Inhibition of Lipase Activity in Detergent Formulations

Whilst investigating saponin activation of lipases, it was also observed that above a given concentration of saponin, instead of continued activation further addition of saponin resulted instead in reduction of enzyme activity. This has a potential application in prevention of lipase activity in the bottle, where saponin is present at a high concentration and might otherwise attack lipase-labile bonds such as ester linkages. At the same time, on dilution of the product full enzyme activation in the wash will be enabled once saponin concentration is diluted.

### Example 4 Showing Saponins as Natural Inhibitors of Lipase Activity—an Approach to Prevent Lipase Catalysed Degradation of Soil Release Polymers

Biochemical assays measuring lipase activity were initially used in high-throughput microtitre plate format to enable different saponins at different doses to be screened as potential inhibitors of Lipex 100 L lipase (Novozymes). Effective inhibitors are sought to prevent the lipase hydrolytic activity towards the soil release polymer which is typically observed. Table 2 shows four saponins which act as inhibitors of Lipex 100 L lipase activity. Tea saponin, Quillaja Bark saponin and Escin are particularly noted for their ability to decrease lipase activity to negligible levels. When using 10 ng/mL lipase (0.3 μM) in this case (this level chosen to ensure that substrate hydrolysis and resultant increase in absorbance measurements falls within the sensitivity of the spectrophotometer) the typical saponin concentration required to inhibit the lipase was around 50-125 μM.

TABLE 2
Initial screen for lipase inhibitory effects of different saponins

Lipex 100L activity in the presence
of saponins (Δabs/min @405 nm)

| Saponin dose | Tea | Quillaja bark | Glycyrrhizic | |
|---|---|---|---|---|
| (μM) | saponin | saponin | acid | Escin |
| 0 | 0.204 | 0.209 | 0.239 | 0.269 |
| 0.01 | 0.205 | 0.227 | 0.244 | 0.257 |
| 0.1 | 0.228 | 0.261 | 0.252 | 0.241 |
| 0.5 | 0.213 | 0.248 | 0.238 | 0.247 |
| 10 | 0.100 | 0.049 | 0.221 | 0.200 |
| 25 | 0.024 | 0.014 | 0.171 | 0.204 |
| 50 | 0.015 | 0.009 | 0.135 | 0.152 |
| 125 | 0.013 | 0.007 | 0.116 | 0.006 |
| 250 | 0.007 | 0.004 | 0.083 | 0.001 |
| 500 | 0.006 | 0.003 | 0.068 | 0.001 |

Similarity between structures of effective saponin inhibitors are observed with common structural features of a triterpenoid backbone to which are linked one or more sugar moieties.

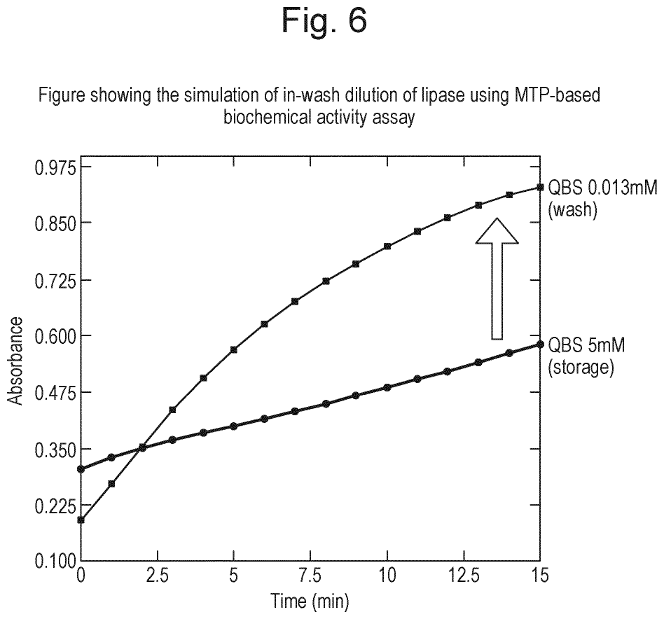

The effects of this inhibition are reversible. FIG. 6 shows how a dilution of the stored lipase/saponin sample (replicating the in-wash dilution) releases the inhibitory effect of the saponin, thus restoring activity. Using a laundry formulation-relevant level of Lipex 100 L (0.4% w/v) in solution containing 5 mM Tea saponin, this was represented by a significantly higher lipase activity in the sample taken from a 1/400 dilution of the sample which contained 5 mM Tea saponin. Laundry formulation contained 0.4% w/v Lipex and 5 mM QBS.

### Example 5 Showing Saponins as Natural Inhibitors of Lipase Activity—an Approach to Prevent Lipase Catalysed Degradation of Soil Release Polymers

Further studies showed that the saponins can be used to inhibit another fungal lipase (Lipex Evity), thus extending the potential applicability of this technology to future generations of laundry lipases.

TABLE 3
showing lipase inhibitory effects of different
saponins against a different lipase

| | Lipex Evity activity activity in the |
|---|---|
| Saponin dose | presence of saponins (Δabs/min @405 nm) |
| (μM) | Tea saponin |
| 0 | 0.135 |
| 0.01 | 0.150 |
| 0.1 | 0.134 |
| 0.5 | 0.140 |
| 10 | 0.021 |
| 25 | 0.007 |
| 50 | 0.006 |
| 125 | 0.003 |
| 250 | 0.002 |
| 500 | 0.001 |

Further examples were carried out, which also showed lipase inhibition by Tea saponin and Quillaja Bark Saponin when a bacterial lipase was used.

### Example 6

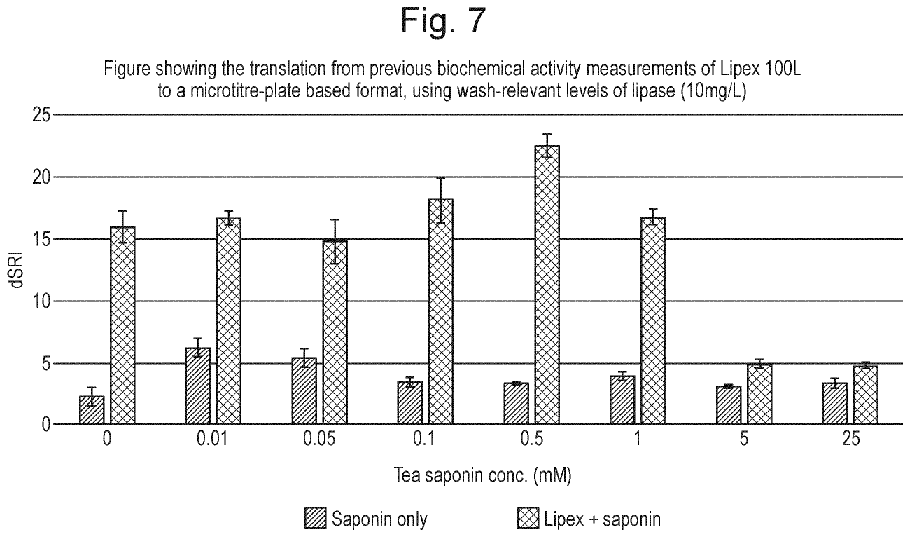

Previous biochemical assay measurements indicated the scalability of this technology to laundry relevant levels of lipase enzyme. Wash studies were subsequently conducted to determine that a maximum final saponin concentration of 1 mM in this formulation is advised (after dilution into wash) to ensure that full lipase cleaning performance is observed (see FIG. 7). Therefore, an excess of saponin can be applied (bearing in mind solubility and cost) in the stored formulation to prevent lipase activity against the SRP.

FIG. 7 highlights that a maximum final inhibitor concentration of 1 mM is suggested (after dilution into wash) to ensure that full lipase cleaning performance towards a beef fat stain (CS61) is maintained in wash conditions whilst still maintaining inhibition in the detergent formulation prior to dilution in use. Wash conducted at 30° C. for 30 min in FH32 water and with 1 g/L formulation containing: LAS 5.8%, SLES 4.5%, NI (Neodol 25-7) 4.5%, fatty acid 0.9%, TEA 8.8%, glycerol 2%, citric acid 1%, polymers/perfume/preservative (5%), and water to 100%).

### Example 7

Various saponins were tested for their ability to inhibit Lipex 100 L lipase (10 ng/mL final). A buffer was used (50 mM Tris pH 8.5) and the experiments were carried out at 25° C. At a fixed dose of 500 μM a number of those tested were effective in lowering the lipase activity. The substrate used for testing as C12 pNP ester (0.1 mM final). These included glycosylated derivatives of oleanolic acid, avenacin, tea tree saponin as well as escin (table 4). Orlistat as a known inhibitor of lipase was also included for comparison (table 4).

The saponins tested (OA 28-x4Gly, Tea saponin, Escin, Avenacin and OA 28-x3Gly) all dramatically inhibited the lipase, ranging from 80% lipase inhibition (OA 28-4xGly) to >90% inhibition (Tea saponin, Escin) to complete inhibition (Avenacin, OA 28-x3Gly). Oleanoic acid, which is not a saponin as it doesn't have the sugar moieties present failed to inhibit the lipase.

TABLE 4
Inhibitory effect of various saponin
derivatives towards Lipex 100L lipase

| | (abs/min @405 nm) |
|---|---|
| Retained/improved lipase activity | |
| Control (lipase only - no saponin) | 0.0545 (±0.0054) |
| Oleanolic acid (OA) | 0.0842 (±0.0084) |
| Lowered lipase activity to complete inhibition | |
| Control (no lipase) | 0.0013 (±0.002) |
| Oleanolic acid 28-x4Gly (OA 28-x4Gly) | 0.0109 (±0.0006) |
| Tea saponin | 0.0045 (±0.0006) |
| Escin saponin | 0.0039 (±0.0027) |
| Avenacin | 0.0013 (±0.0006) |
| Orlistat | −0.00032 (±0.0003) |
| Oleanolic acid 28-x3Gly (OA 28-x3Gly) | −0.0011 (±0.0005) |

The examples fully demonstrate that relatively low levels of saponin in the wash liquor can activate lipase. Relatively high levels of saponins present in the detergent formulation can inhibit lipases, allowing for inclusion of materials in the formulation that are sensitive to lipases. These effects can be seen individually or in concert. Highly preferred levels of saponin can inhibit lipase in the detergent formulation (i.e. the detergent sold to consumers in the market), but still activate lipase when the product is diluted in the wash liquor. These effects are demonstrated across many different lipase enzymes and for many different saponins.

1-12. (canceled)

13. A method of inhibiting lipase activity in a detergent composition, the method comprising incorporating from 0.25 to 40 wt. % of a saponin into the detergent composition, wherein the detergent composition is a home care detergent composition.

14. The method according to claim 13, wherein the detergent composition further comprises from 0.0005 to 2.5 wt. % of a lipase enzyme.

15. The method according to claim 14, wherein the lipase enzyme is bacterial or fungal in origin.

16. The method according to claim 13, wherein the saponin has a triterpenoid backbone, and one or more sugar moieties attached to the triterpenoid backbone.

17. The method according to claim 13, wherein the saponin has a triterpenoid backbone, and two or more sugar moieties attached to the triterpenoid backbone.

18. The method according to claim 13, wherein the detergent composition comprises from 1 to 60 wt. % of a surfactant, the surfactant not including saponin.

19. The method according to claim 13, wherein the detergent composition comprises anionic and/or nonionic surfactant.

20. The method according to claim 13, wherein the composition is a liquid, a gel or a powder.

21. The method according to claim 13, wherein the laundry detergent composition further comprises from 0.1 to 8 wt. % of alkoxylated polyamine, wherein the alkoxylated polyamine is an alkoxylated polyethylenimine, alkoxylated polypropylenimine and/or mixtures thereof, wherein the alkoxylation is an ethoxylation, an propoxylation or a mixture thereof.

22. The method according to claim 13, wherein the laundry detergent composition further comprises from 0.1 to 8 wt. % of a soil release polymer, wherein the soil release polymer is a polyester soil release polymer.

23. The method according to claim 13, further comprising one or more additional enzymes selected from: proteases, cellulases, alpha-amylases, peroxidases/oxidases, pectate lyases, mannanases, and/or mixtures thereof.

24. The method according to claim 13, wherein the detergent composition comprises from 0.5 to 30 wt. % of the saponin.

25. The method according to claim 13, wherein the detergent composition comprises from 0.5 to 25 wt. % of the saponin.

26. The method according to claim 13, wherein the detergent composition comprises from 1 to 20 wt. % of the saponin.

27. The method according to claim 13, wherein the detergent composition comprises from 1 to 15 wt. % of the saponin.

28. The method according to claim 14, wherein the detergent composition comprises from 0.001 to 2 wt. % of the lipase enzyme.

29. The method according to claim 14, wherein the detergent composition comprises from 0.005 to 1 wt. % of the lipase enzyme.

30. The method according to claim 18, wherein the detergent composition comprises from 2.5 to 50 wt. % of the surfactant.

31. The method according to claim 18, wherein the detergent composition comprises from 4 to 40 wt. % of the surfactant.

32. The method according to claim 18, wherein the detergent composition comprises from 8 to 35 wt. % of the surfactant.
